(19) United States
(12) Patent Application Publication
(10) Pub. No.: US 2008/0132283 A1
(43) Pub. Date: Jun. 5, 2008

(54) MOBILE STATION THAT PROVIDES FEEDBACK INDICATIVE OF WHETHER IT IS BEING PROPERLY HELD

(75) Inventors: Lorenzo A. Ponce De Leon, Lake Worth, FL (US); William P. Alberth, Prairie Grove, IL (US); Timothy Heffield, Sunrise, FL (US); Jose E. Korneluk, Lake Worth, FL (US); Michael D. Kotzin, Buffalo Grove, IL (US); Benjamin Snow, Deerfield Beach, FL (US); Geroncio Tan, Sunrise, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/686,309

(22) Filed: Mar. 14, 2007

Related U.S. Application Data
(60) Provisional application No. 60/867,827, filed on Nov. 30, 2006.

(51) Int. Cl. H04B 1/38

(52) U.S. Cl. 455/566

(57) ABSTRACT

A method (300) for improving a user's experience with a mobile station (100). The method can include detecting whether the mobile station is being held properly. In response to detecting that the mobile station is not being held properly, an indicator (140, 145) can be presented via a user interface (230) to indicate to a user that the mobile station is being held improperly. The method also can include, responsive to detecting that the mobile station is being held properly, generating an indicator via the user interface that indicates to the user that the mobile station is being held properly.

### CROSS REFERENCES TO RELATED APPLICATIONS

This application claims benefit of U.S. provisional patent application Ser. No. 60/867,827, filed Nov. 30, 2006, which is herein incorporated by reference.

### BACKGROUND OF THE INVENTION

1. Field of the Invention

The present invention generally relates to mobile stations and, more particularly, to a mobile station user interface.

2. Background of the Invention

A mobile station typically communicates by establishing an RF communication link with a node of a communications network. For example, a mobile station may establish an RF communication link with a base station or a repeater of a cellular communications network. To support the RF communication link, a mobile station generally includes one or more transceivers and one or more antennas.

For a variety of reasons, mobile stations usually transmit at relatively low power, typically within the watt range. Moreover, the signal strength of received signals also is fairly low. Thus, the efficiency with which a mobile station transmits and receives RF signals is a critical factor affecting mobile station performance. When the efficiency is adversely affected, for instance by improper positioning of a finger next to the mobile station's antenna, a call session can be interrupted or dropped, which is undesirable.

### SUMMARY OF THE INVENTION

The present invention relates to a method for improving a user's experience with a mobile station. The method can include detecting whether the mobile station is being held properly. In response to detecting that the mobile station is not being held properly (i.e. being held improperly), an indicator can be presented via a user interface to indicate to a user that the mobile station is being held improperly. The method also can include, responsive to detecting that the mobile station is being held properly, generating an indicator via the user interface that indicates to the user that the mobile station is being held properly. Further, a second indicator can be transmitted to a network node in response to detecting that the mobile station is not being held properly.

Detecting whether the mobile station is being held properly can include detecting whether the mobile station is being held in a manner that will interfere with RF communications on the mobile station. Detecting whether the mobile station is being held in a manner that will interfere with RF communications can include detecting proximity of an appendage to an antenna of the mobile station. For example, at least one parameter corresponding to a loading characteristic of an antenna on the mobile station can be measured. Examples of such a parameter include, but are not limited to, a voltage standing wave ratio (VSWR), an amount of reflected energy or a load impedance. Detecting whether the mobile station is being held in a manner that will interfere with RF communications also can include measuring an insertion phase delay, a power compression or a gain of a power amplifier.

In another arrangement, detecting whether the mobile station is being held properly can include taking a plurality of measurements of an operating parameter of a transmitter associated with the mobile station and determining whether the plurality of measurements correlate to a particular profile associated with the mobile station being improperly held. Taking the plurality of measurements of the operating parameter can include taking a plurality of measurements of a gain of a power amplifier and determining from the gain a compression of the power amplifier. The method further can include determining whether there are a number of dropped calls that exceed a threshold value, determining whether a radio signal strength indicator (RSSI) is below a threshold value, or determining whether a frequency of a condition of the mobile station being improperly held exceeds a threshold value.

The method also can include detecting whether an antenna is positioned properly. Responsive to detecting that the antenna is not positioned properly (i.e. is positioned improperly), an indicator can be presented via a user interface. The indicator can indicate to a user that the antenna is positioned improperly.

In yet another arrangement, a second antenna can be selected in response to detecting that the mobile station is not being held properly. The second antenna can be used by the mobile station to communicate.

The present invention also relates to a mobile station that includes at least one sensor that detects whether the mobile station is being held properly and a user interface that, responsive to detecting that the mobile station is not being held properly, presents an indicator that indicates to a user that the mobile station is being held improperly. The user interface also can generate an indicator that indicates to the user that the mobile station is being held properly in response to the sensor detecting that the mobile station is being held properly.

The sensor can detect whether the mobile station is being held in a manner that will interfere with RF communications on the mobile station. For example, the sensor can detect a proximity of an appendage to an antenna of the mobile station. The sensor also can measure at least one parameter corresponding to a loading characteristic of an antenna on the mobile station. The sensor also can measure an insertion phase delay, a power compression or a gain of a power amplifier.

The mobile station also can include a sensor that detects whether an antenna is positioned properly. In response to the sensor detecting that the antenna is positioned improperly, the user interface can present an indicator that indicates to a user that the antenna is positioned improperly.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a front view of a mobile station that is useful for understanding the present invention;

FIG. 2 depicts a block diagram of a mobile station that is useful for understanding the present invention;

FIG. 3 is a flowchart that is useful for understanding the present invention;

FIG. 4 is a flowchart that is useful for understanding another arrangement of the present invention; and

FIG. 5 is a flowchart that is useful for understanding yet another arrangement of the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system that provides feedback to a user that indicates to the user whether he is correctly holding a mobile station. The feedback also may indicate to the user the proper manner in which to hold the mobile station. For example, audio and/or visual indicators can be provided to direct the user on how to hold the mobile station. In comparison to a mobile station that is held incorrectly, a mobile station that is held in the correct manner generally will exhibit superior RF transmit and/or receive characteristics, thereby reducing the risk of interrupted or dropped calls.

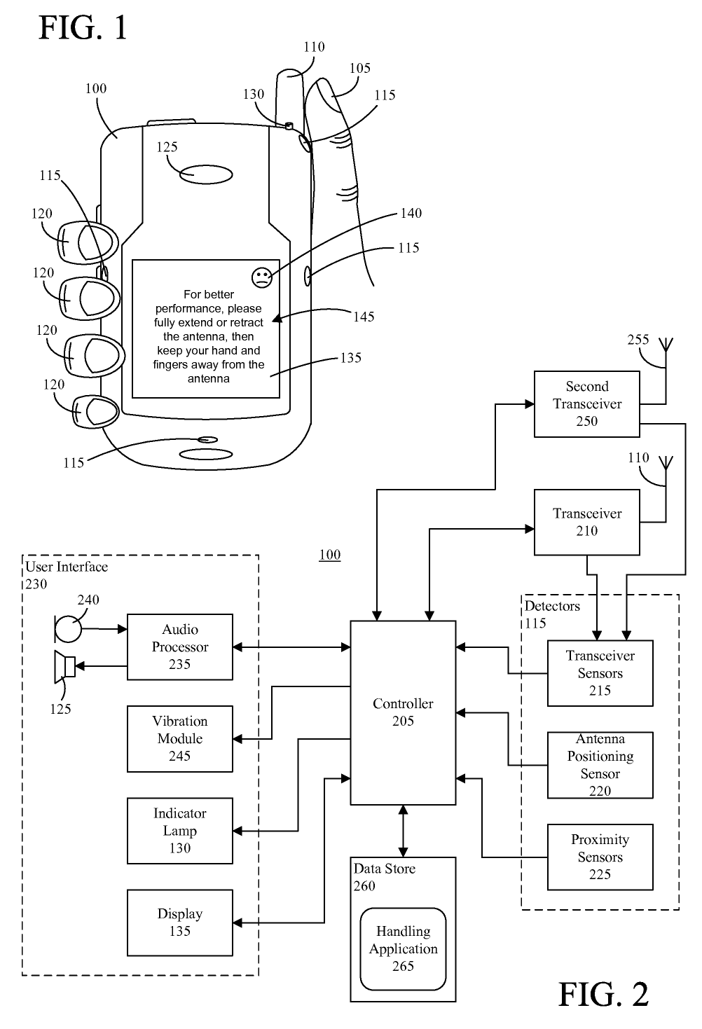

FIG. 1 depicts a front view of a mobile station 100 that is useful for understanding the present invention. In one arrangement, the mobile station 100 can be a mobile telephone, a mobile radio or a personal digital assistant. In another arrangement, the mobile station can be a mobile computer, a portable gaming device, or any other electronic device having a communication antenna.

If the mobile station 100 is held in the manner shown in which an appendage 105 is improperly positioned, for instance the appendage 105 is touching or positioned proximate to the mobile station's antenna 110, the appendage 105 may adversely affect loading characteristics of the antenna 110. In particular, the appendage 105 may change a load impedance of the antenna 110, which can degrade the performance of the antenna 110 and the mobile station's transceiver. For example, in transmit mode the change in load impedance may increase the amount of transmit energy reflected from the antenna back to the mobile station's transceiver, thereby resulting in less energy being transmitted. In receive mode the change in antenna impedance can increase an amount of receive energy reflected from the mobile station's transceiver back to the antenna 110, thereby resulting in less energy being received by the mobile station 100.

Further, if the antenna 110 is not in its fully retracted position or in its fully extended position, improper antenna load impedance may be presented to the mobile station's transceiver. An improper load impedance due to improper antenna positioning also may increase the amount of transmit energy reflected from the antenna 110 back to the mobile station's transceiver, or increase an amount of receive energy reflected from the transceiver back to the antenna 110.

To detect when the mobile station 100 is being improperly held and/or whether the antenna 110 is improperly positioned, one or more detectors 115 can be provided. The detectors 115 can include sensors that are positioned proximate to the antenna 110 and/or in other locations on the mobile station 100 suitable for detecting proximity of the appendage 105, appendages 120, a hand, or any other body part. The detectors 115 also can include sensors that detect whether the antenna is fully retracted, fully extended, or partially extended. As will be discussed further, the detectors 115 also can include one or more sensors that detect presence or proximity of an object by measuring electrical parameters associated with the antenna 110 and/or the mobile station's transceiver.

In response to the detectors 115 detecting that the mobile station 100 is being improperly held, for example the appendage 105, one or more of the appendages 120, a hand, or any other body part is improperly positioned, the mobile station 100 can present an indicator that alerts the user that the mobile station 100 is being improperly held. Similarly, in response to the detectors 115 detecting the antenna being partially extended, the mobile station 100 can present an indicator that alerts the user that the extension of the antenna is improper.

In response to the detectors 115 detecting that the mobile station 100 is being held properly, for instance in response to the detectors not detecting any objects proximate to the antenna 110 and/or any other sensitive areas, the mobile station 100 can present an indicator that indicates the mobile station 100 is being properly held. Likewise, and indicator that indicates proper extension of the antenna 110 can be presented when the antenna 110 is fully extended or fully retracted.

The indicators can be presented in any suitable manner. In one arrangement, the indicators can comprise audio signals generated via an output transducer 125 (e.g. a loudspeaker). When the mobile station 100 is being held improperly, an audible indicator can instruct the user to change the manner in which the mobile station 100 is being held. For instance, the audible indicator can indicate to the user to keep their body parts away from the antenna 110 or any other sensitive areas on the mobile station 100. When the antenna 110 is partially extended, an audible indicator can instruct the user to completely extend or retract the antenna 110. The audible indicator also can notify the user when the mobile station 100 is properly held and/or when the antenna is properly extended or retracted. The audible indicators can comprise, for example, a tone, a series of tones, an audio message, or any other suitable audio signal.

In another arrangement, the indicators can be provided as vibrations. For example, the mobile station 100 can include a vibration module. In response to the detectors 115 detecting that the mobile station 100 is being improperly held or the antenna is partially extended, the vibration module can vibrate the mobile station 100. The vibration can be provided in accordance with a vibration pattern that is selected to indicate a particular issue. For example, a first vibration pattern can indicate the mobile station 100 is being held improperly and a second vibration pattern can indicate that the antenna 110 is partially extended.

In yet another arrangement, one or more visual indicators can be provided. For example, an indicator lamp 130 can be positioned proximate to the antenna 110. Indicator lamps also can be positioned at other sensitive areas on the mobile station 100. The indicator lamp 130 can illuminate a first color of light, such as red, when the mobile station 100 is improperly held or when the antenna 110 is partially extended, and illuminate a second color of light, such as green, when the mobile station is properly held and the antenna 110 is fully extended or retracted. In another arrangement, the first indicator lamp 130 can indicate whether the antenna is fully extended or retracted and a second indicator lamp (not shown) can indicate whether the mobile station 110 is being properly held. Any number of additional indicator lamps also can be included and the invention is not limited in this regard.

A visual alert also can be provided via a display 135. For instance, a first icon 140 can be presented on the display 135 when the mobile station 100 is improperly held or the antenna 110 is partially extended. In addition, instructions on proper antenna positioning and a proper holding technique can be presented on the display 135. For example, text 145 or an image can be presented to indicate how the antenna 110 should be positioned and how the mobile station 100 should be held. When the antenna 110 is fully extended or retracted and the mobile station 100 is properly held, the first icon 140 can be changed to a second icon indicating such and any text 145 can be removed from the display 135.

Further, a second indicator can be transmitted to a network node in response to detecting that the mobile station 100 is not being held properly or that the antenna 100 is not properly positioned. The second indicator can indicate the detected circumstance which triggered the second indicator to be transmitted. The network node can be, for example, a server, a base transceiver station, a base station controller, a mobile switching center or any other node of a communications network. In such an arrangement, the communications network can gather statistical data pertaining to improper use of mobile stations.

FIG. 2 depicts a block diagram of the mobile station 100 that is useful for understanding the present invention. The mobile station 100 can include a controller 205. The controller 205 can comprise, for example, a central processing unit (CPU), a digital signal processor (DSP), an application specific integrated circuit (ASIC), a programmable logic device (PLD), a plurality of discrete components that cooperate to process data, and/or any other suitable processing device. The controller 205 can be a primary controller on the mobile station 100 that is tasked with other functions, or the controller 205 can be dedicated to performing the processes and functions described herein.

The mobile station 100 also can include a transceiver 210 that is communicatively linked to the antenna 110 and used by the mobile station 100 to communicate with a communications network or other wireless communication devices. The transceiver 210 can include a transmitter and a receiver and can communicate data via IEEE 802 wireless communications, including 802.11 and 802.16 (WiMax), GSM, TDMA, CDMA, WCDMA, OFDM, direct wireless communication, TCP/IP, WPA, WPA2, or any other suitable form of wireless communications and/or communications protocols.

As noted, the mobile station 100 can include one or more detectors 115 that detect whether the mobile station 100 is being improperly held and whether the antenna 110 is positioned properly. The detectors 115 can include one or more transceiver sensors 215 that monitor the transceiver's transmitter, the transceiver's receiver and/or signals communicated between the transceiver 210 and the antenna 110. One example of a transceiver sensor 215 is a sensor that measures a voltage standing wave ratio (VSWR), for instance on a transmission line linking the transceiver 210 to the antenna 110. Another example of a transceiver sensor 215 is a sensor that measures an amount of reflected energy from the antenna 110 and/or a load impedance of the antenna 110. Other examples of the transceiver sensors 215 can include sensors that measure an insertion phase delay, a power compression and/or a gain of the transceiver's transmitter (e.g. by monitoring the transmitter's power amplifier). For example, a plurality of measurements of a gain of the transceiver's power amplifier can be taken and from the gain measurements a determination can be made whether the power amplifier is operating in compression. Still, any other sensors can be used that measure parameters that correlate to, or are influenced by, antenna loading characteristics and the invention is not limited in this regard.

The detectors 115 also can include an antenna positioning sensor 220. The antenna positioning sensor 220 can detect whether the antenna 110 is fully retracted, fully extended or partially extended.

Further, the detectors 115 can include one or more proximity sensors 225. The proximity sensors 225 can comprise capacitive sensors, thermal sensors, photovoltaic sensors, optical sensors, or any other sensors that can be used to detect presence or proximity of an object. In one arrangement, the proximity sensors 225 can be tuned to detect presence of human tissue. For example, a capacitive sensor can be tuned to detect a capacitance value associated with human tissue. Similarly, a thermal sensor can be tuned to detect thermal energy associated with human tissue. Further, an optical sensor can be configured to detect an appendage, such as a finger.

Signals generated by the detectors 115 can be processed to determine whether such signals indicate that the mobile station 100 is being held improperly and/or whether the antenna is properly extended or retracted. For example, a signal from a transceiver sensor 215 indicating that the VSWR and/or signal energy reflection on the transmission line coupling the transceiver 210 to the antenna 110 are higher than threshold values can be indicative of the mobile station 100 being held improperly. A signal from a transceiver sensor 215 indicating that the load impedance of the antenna 110 is not within a particular range also can be indicative of the mobile station 100 being held improperly. Likewise, a signal from a proximity sensor 225 that detects an object or tissue in an improper position, for instance next to the antenna 110, can be indicative of the mobile station 100 being held improperly. A signal from the antenna positioning sensor 220 indicating that the antenna 110 is partially extended can be indicative of improper antenna 110 positioning.

In one arrangement, processing of signals generated by the detectors 115 can be performed by the controller 205. In another arrangement, one or more dedicated sensor signal processors (not shown) can be provided. For example, in an arrangement in which the proximity sensors 225 include an optical sensor, an image processor can be provided. In an arrangement in which the transceiver sensors 215 include sensors that measure analog parameters, an analog to digital converter can be provided. Still, any other processors suitable for processing sensor signals can be provided and the invention is not limited in this regard.

The mobile station 100 also can include a user interface 230. The user interface 230 can include an audio processor 235 communicatively linked to the output audio transducer 125. The audio processor 235 also can be communicatively linked to an input audio transducer 240 (e.g. a microphone). The audio processor 235 can be integrated with the controller 205, or provided as a separate component that is communicatively linked to the controller 205. For example, the audio processor 235 can comprise a CPU, a DSP, an ASIC, a PLD, a plurality of discrete components that cooperate to process audio data, and/or any other suitable audio processing device.

In operation, the audio processor 235 can receive one or more signals generated by the controller 205 in response to a determination that the mobile station 100 is being held properly or being held improperly, or the antenna 110 being positioned properly or improperly. The audio processor 235 can process such signals to generate an audio signal, and communicate the audio signal to the output audio transducer 125 for presentation to the user. For example, if the mobile station 100 is being held improperly, in response to a signal received from the controller 205, the audio processor 235 can generate an audio signal that indicates to a user that the mobile station 100 is being held improperly. If the antenna 110 is not fully retracted or fully extended, in response to a signal received from the controller 205, the audio processor 235 can generate an audio signal that indicates to a user that the antenna needs to be fully retracted or extended. If the user corrects the way in which he is holding the mobile station or corrects the positioning of the antenna 110, in response to a signal received from the controller 205, the audio processor 235 can generate an audio signal that indicates the mobile station 100 is now being held properly and/or the antenna 110 is properly positioned.

The user interface 230 also can include a vibration module 245. The vibration module 245 can receive signals from the controller 205 in response to a determination of whether the mobile station 100 is being held improperly. For example, a fist vibration signal can be received if the mobile station 100 is being held improperly, and a second vibration signal can be received if the antenna 110 is improperly positioned. A third vibration signal can be generated if the mobile station 100 is being held properly and the antenna 110 is properly positioned.

The indicator lamp 130 and/or display 135 also can be provided as components of the user interface 230. As noted, the indicator lamp 130 and/or the display 135 indicate whether the mobile station 100 is being held properly and/or the antenna 110 is properly positioned. For example, the indicator lamp 130 can illuminate a color of light that indicates whether the mobile station 100 is being properly held and the antenna is properly positioned. Similarly, the display 135 can present an icon that indicates whether the mobile station 100 is being properly held and whether the antenna is properly positioned. Moreover, if the mobile station 100 is not being properly held, the display 135 can present an indicator that indicates to the user how to properly hold the mobile station 100. Further, if the antenna 110 is not properly positioned, the display 135 can present an indicator that indicates to the user how to position the antenna 110, for example how to retract or extend the antenna. Such indicators can include an icon, a figure, a picture, text, or the like. Moreover, a sequence of icons, figures, pictures or text can be presented.

In one arrangement, the mobile station 100 can include a second transceiver 250 and/or a second antenna 255. Alternatively, the second transceiver 250 may be on a different system that is communicatively linked to the mobile station 100. The second transceiver 250 also can include a transmitter and a receiver and can communicate data via IEEE 802 wireless communications, including 802.11 and 802.16 (WiMax), GSM, TDMA, CDMA, WCDMA, OFDM, direct wireless communication, TCP/IP, WPA, WPA2, or any other suitable form of wireless communications and/or communications protocols. In response the mobile station being improperly held so as to interfere with the performance of the transceiver 210 and/or antenna 110, or in response to the antenna 110 not being properly positioned, the mobile station 100 can begin communicating via the second transceiver 250 and antenna 255. In one arrangement, the mobile station 100 can completely cease communicating via the transceiver 210 and exclusively communicate via the second transceiver 250. In another arrangement, the mobile station 100 can implement diversity communications using both the transceiver 210 and the second transceiver 250.

In yet another arrangement, both the antenna 110 and the antenna 255 can be communicatively linked to the transceiver 210. In response to the transmit and/or receive characteristics of the antenna 110 being negatively impacted due to the mobile station 100 being held improperly or improper positioning of the antenna 110, the transceiver 210 can cease communicating via the antenna 110 and begin communicating via the antenna 255. Alternately, the transceiver 210 can modify the method in which it communicates in response to the improper positioning of the antenna 100 or the mobile station 100 being held improperly. For example, the transceiver can change a modulation scheme, increase a coding gain, or implement other operational changes that improve the data reliability or reduce the data bandwidth of signals being communicated.

The mobile station 100 further can include a data store 260. The data store 260 can include one or more storage devices, each of which can include a magnetic storage medium, an electronic storage medium, an optical storage medium, a magneto-optical storage medium, and/or any other storage medium suitable for storing digital information. In one arrangement, the data store 260 can be integrated into the controller 205.

A handling application 265 can be contained on the data store 260. The controller 205 can execute the handling application 265 to implement the processes and methods described herein. For example, the handling application 265 can be executed to receive signals from the detectors 115 that indicate whether the mobile station 100 is being properly held and whether the antenna is positioned properly, and generate output signals in response to such determinations. For example, if the mobile station 100 is being held properly and the antenna 110 is properly positioned, the handling application 265 can generate corresponding output signals to the user interface 230. If the mobile station 100 is being held improperly or the antenna 110 is improperly positioned, the handling application 265 can generate corresponding output signals to the user interface 230, as well as signals that may be processed to generate one or more indicators which inform the user how to properly hold the mobile station 100 or position the antenna 110. The handling application 265 also can select the second transceiver 250 and/or antenna 255 with which to communicate in response to the mobile station 100 being held improperly or the antenna 110 being improperly positioned.

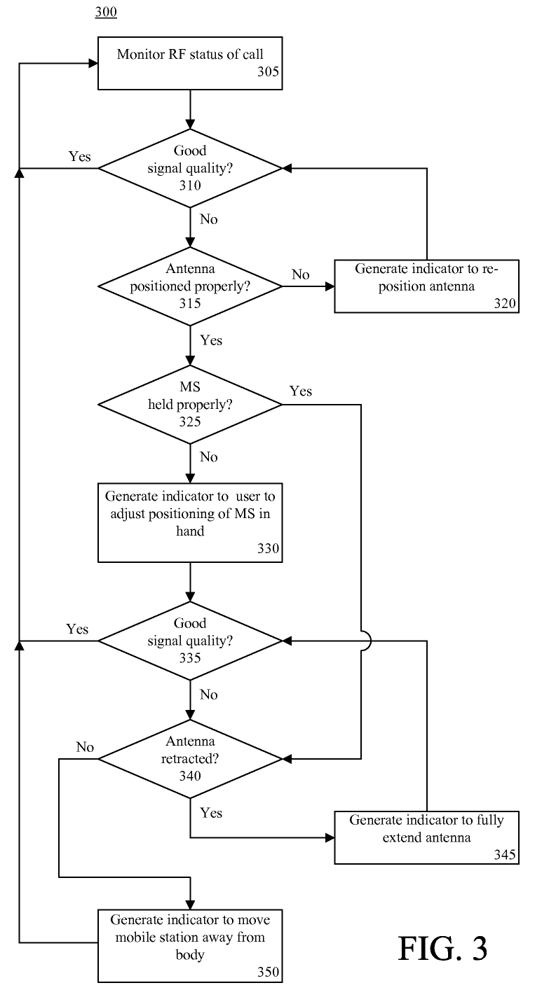

FIG. 3 is a flowchart presenting a method 300 that is useful for understanding the present invention. The method 300 can begin in a state in which a call session has been established on a mobile station. Beginning at step 305, the RF status of the call session can be monitored. Referring to decision box 310, if the mobile station is transmitting and receiving with good signal quality, the RF status of the call can continue to be monitored.

If, however, the mobile station is not transmitting and receiving good signal quality, at step 315 a determination can be made whether the antenna is properly positioned. For example, a determination can be made whether the antenna is only partially extended. If the antenna is not properly positioned, at step 320 an indicator can be generated to alert a user to re-position the antenna. For example, the alert can instruct the user to fully retract and/or fully extend the antenna.

At step 310, the signal quality can again be measured. Again referring to decision box 315, if the antenna is positioned properly, at step 325 a determination can be made whether the mobile station is being held properly, for example whether a hand or appendage is touching or located proximate to the mobile station's antenna. If the mobile station is not held properly, at step 330 an indicator can be generated to alert the user to adjust positioning of the mobile station in the user's hand. For example, the alert can indicate to the user to move his hand and/or fingers away from sensitive areas on the mobile station, such as the antenna.

Referring to decision box 335, if good RF signal quality is detected, the process can return to step 305 and the RF status of the call can continue to be monitored. If the signal quality still is not good, at decision box 340 a determination can be made whether the antenna is retracted. If the antenna is retracted, at step 345 an indicator can be generated to alert the user to extend the antenna, and at step 335 the quality of the RF signal again can be determined. If the antenna is already in the fully extended position and the signal quality still is not good, at step 350 an indicator can be generated to alert the user to move the mobile station away from the user's body. The process then can return to step 305 and monitoring of the RF status of the call can continue.

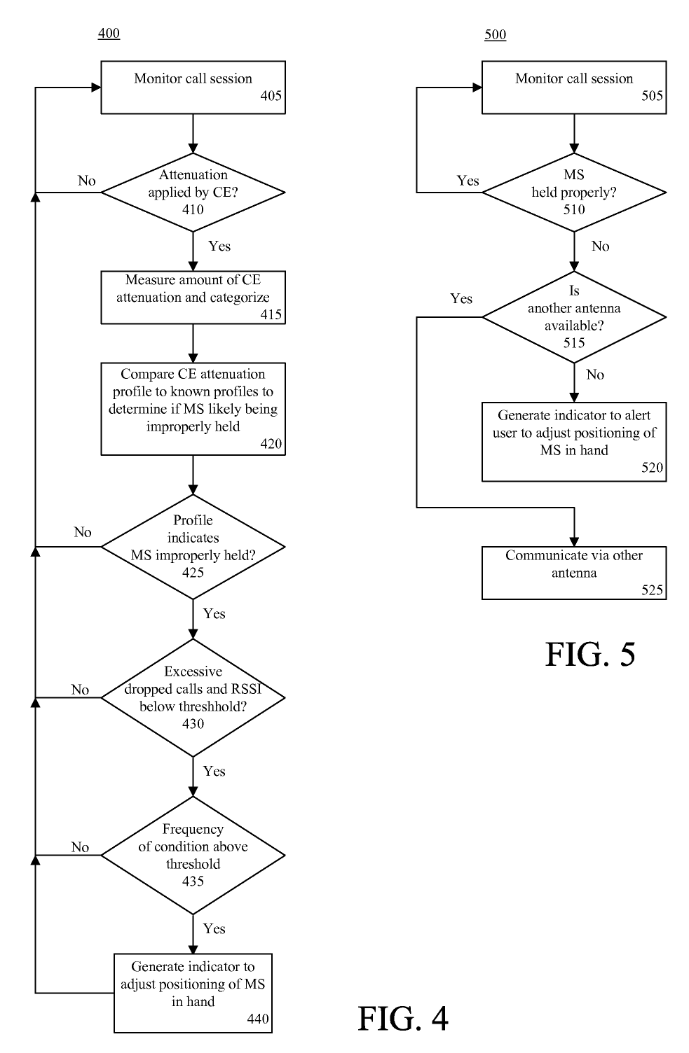

FIG. 4 is a flowchart presenting a method 400 that is useful for understanding another arrangement of the present invention. The method 400 can be implemented on a mobile station which includes a circulator elimination (CE) algorithm. A CE algorithm is an algorithm that may be implemented by a DSP to determine when a transceiver's power amplifier is going into compression (e.g. due to being overdriven) and to reduce such compression by attenuating the amplitude of the power amplifier's input signal. Oftentimes the power amplifier's compression is caused by an improper load being presented at the power amplifier's output, for example due to improper antenna loading characteristics caused by the mobile station being held improperly. Accordingly, the frequency in which the CE algorithm attenuates the input signal and the amount of signal attenuation can indicate whether the amplifier compression is being caused by the mobile station being improperly held.

The method 400 can begin in a state in which a call session has been established on a mobile station and the mobile station has been configured to generate user indicators to alert users to properly hold the mobile station. At step 405, the call session can be monitored. Referring to decision box 410, if the attenuation is applied to the CE algorithm in response to the power amplifier going into compression, at step 415 a level of attenuation applied to the power amplifier's input signal in order to correct the compression condition can be measured and categorized. For example, assume that ten categories of attenuation are defined between 0 and 3 dB. A first category can be defined to cover the range of 0.01 dB-0.30 dB, a second category can be defined to cover the range of 0.31 dB-0.60 dB, a third category can be defined to cover the range of 0.61 dB-0.9 dB, and so on. Each of the categories can be associated with a counter. Each counter can comprise an integer that represents the number of times over a given period that the level of attenuation applied by the CE algorithm falls into a particular category with which the counter is associated. Thus, if the measured amount of attention applied by the CE algorithm is 0.50 dB, the counter corresponding to the second category (0.31 dB-0.60 dB) can be incremented by one.

Proceeding to step 420, the CE attenuation profile (i.e. the attenuation level categories and their corresponding counters) can be compared to known CE profiles to determine whether it is likely that the mobile station is being improperly held. For example, a known profile can indicate that if the average CE attenuation exceeds a threshold value, it is likely that the mobile station is being improperly held. Another profile may indicate that if the standard deviation of the counters for the various categories exceeds a known value, it is likely that the mobile station is being improperly held. Still, the known profiles can be established in any other suitable manner and the invention is not limited in this regard.

Continuing to decision box 425, if the CE attenuation profile indicates that the mobile station is being improperly held, at decision box 430 a determination can be made whether the number of dropped calls caused by the mobile station being held improperly is excessive (e.g. exceed a threshold value) and whether a radio signal strength indicator (RSSI) is below a threshold value. If the number of dropped calls is excessive and the RSSI is below the threshold value, the process can proceed to decision box 435.

At step 435, a determination can be made whether the frequency of the condition of the mobile station being improperly held exceeds a threshold value. If so, at step 440 an indicator can be generated to alert the user to adjust positioning of the mobile station in the user's hand. If the answer to the decision at any of the decision boxes 410, 425, 430 and 435 is “no,” the process can return to step 405 and monitoring of the call session can continue. Thus, if the user only occasionally holds the mobile station improperly, the user will not be burdened with the alerts informing him to adjust the way he is holding the mobile station. The indicator generated in step 440 also may be stored in the mobile station's data store. The indicator may be immediately transmitted by the transceiver or transmitted after some time delay.

FIG. 5 is a flowchart presenting a method 500 that is useful for understanding yet another arrangement of the present invention. At step 505 a call session can be monitored. At decision box 510, a determination can be made whether the mobile station is being held properly. If the mobile station is not being held properly, at decision box 515 a determination can be made whether another antenna is available to be used for the call session. If another antenna is not available, at step 520 an indicator can be generated and presented to a user alerting the user to adjust positioning of the mobile station in the user's hand. If, however, there is another antenna available, at step 525 the mobile station can select the other antenna and begin communicating via the other antenna.

In an arrangement in which the mobile station comprises a single transceiver and a plurality of antennas, the transceiver can switch the antenna that it uses to communicate. In an arrangement in which the mobile station comprises a plurality of transceivers, each of which is communicatively linked to its own antenna, the mobile station can switch the transceiver that it uses to communicate.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for improving a user's experience with a mobile station, comprising:
detecting whether the mobile station is being held properly; and
responsive to detecting that the mobile station is not being held properly, presenting an indicator via a user interface that indicates to a user that the mobile station is being held improperly.

2. The method of claim 1, further comprising:
responsive to detecting that the mobile station is being held properly, generating an indicator via the user interface that indicates to the user that the mobile station is being held properly.

3. The method of claim 1, wherein detecting whether the mobile station is being held properly comprises detecting whether the mobile station is being held in a manner that will interfere with RF communications on the mobile station.

4. The method of claim 3, wherein detecting whether the mobile station is being held in a manner that will interfere with RF communications comprises detecting proximity of an appendage to an antenna of the mobile station.

5. The method of claim 3, wherein detecting whether the mobile station is being held in a manner that will interfere with RF communications comprises measuring at least one parameter corresponding to a loading characteristic of an antenna on the mobile station.

6. The method of claim 5, wherein measuring the at least one parameter comprises measuring a voltage standing wave ratio (VSWR), an amount of reflected energy or a load impedance.

7. The method of claim 3, wherein detecting whether the mobile station is being held in a manner that will interfere with RF communications comprises measuring an insertion phase delay, a power compression, or a gain of a power amplifier.

8. The method of claim 1, wherein detecting whether the mobile station is being held properly comprises:
taking a plurality of measurements of an operating parameter of a transmitter associated with the mobile station; and
determining whether the plurality of measurements correlate to a particular profile associated with the mobile station being improperly held.

9. The method of claim 8, wherein taking the plurality of measurements of the operating parameter comprises:
taking a plurality of measurements of a gain of a power amplifier in response to compression of the power amplifier being detected; and
determining from the gain a compression of the power amplifier.

10. The method of claim 9, further comprising determining whether there are a number of dropped calls that exceed a threshold value, determining whether a radio signal strength indicator (RSSI) is below a threshold value, or determining whether a frequency of a condition of the mobile station being improperly held exceeds a threshold value.

11. The method of claim 1, further comprising:
detecting whether an antenna is positioned properly; and
responsive to detecting that the antenna is not positioned properly, presenting an indicator via the user interface that indicates to the user that the antenna is positioned improperly.

12. The method of claim 1, further comprising:
responsive to detecting that the mobile station is not being held properly, selecting a second antenna; and
communicating via the second antenna.

13. The method of claim 1, further comprising transmitting a second indicator to a network node in response to detecting that the mobile station is not being held properly.

14. A mobile station, comprising:
at least one sensor that detects whether the mobile station is being held properly; and
a user interface that, responsive to the sensor detecting that the mobile station is not being held properly, presents an indicator that indicates to a user that the mobile station is being held improperly.

15. The mobile station of claim 14, wherein the user interface generates an indicator that indicates to the user that the mobile station is being held properly in response to the sensor detecting that the mobile station is being held properly.

16. The mobile station of claim 14, wherein the sensor detects whether the mobile station is being held in a manner that will interfere with RF communications on the mobile station.

17. The mobile station of claim 16, wherein the sensor detects a proximity of an appendage to an antenna of the mobile station.

18. The mobile station of claim 16, wherein the sensor measures at least one parameter corresponding to a loading characteristic of an antenna on the mobile station, or an insertion phase delay, a power compression or a gain of a power amplifier.

19. The mobile station of claim 14, further comprising:
a sensor that detects whether an antenna is positioned properly;
wherein, in response to the sensor detecting that the antenna is positioned improperly, the user interface presents an indicator that indicates to the user that the antenna is positioned improperly.

20. A program storage device readable by a machine, tangibly embodying a program of instructions executable by the machine to perform method steps for improving a user's experience with a mobile station, said method steps comprising:
detecting whether the mobile station is being held properly; and
responsive to detecting that the mobile station is not being held properly, presenting an indicator via a user interface that indicates to a user that the mobile station is being held improperly.
